(19) United States
(12) Patent Application Publication
(10) Pub. No.: US 2016/0151890 A1
(43) Pub. Date: Jun. 2, 2016

(54) CLAMP DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XIAO-XUE SONG, Shenzhen (CN)

(21) Appl. No.: 14/590,212

(22) Filed: Jan. 6, 2015

(30) Foreign Application Priority Data
Nov. 28, 2014 (CN) 201410713068.4

(51) Int. Cl. B25B 5/02

(52) U.S. Cl. CPC B25B 5/02

(57) ABSTRACT

A clamp device is used for holding a plate type work-piece. The clamp device includes a base. The base includes a top surface and a bottom surface. A first positioning member and two guiding slots are formed on the base. Two movable members are located on the guiding slots, respectively. The movable member can slide along the guiding slot. The two movable members and the first positioning member form a clamping space together.

### FIELD

The disclosure relates to clamping fixtures, and particularly relates to a clamp device for holding work-pieces with different sizes.

### BACKGROUND

Different kinds of tests need to be processed on assembled electronic devices to test different performances thereof, which always need different clamp devices.

### BRIEF DESCRIPTION OF THE DRAWINGS

Implementations of the present technology will now be described, by way of example only, with reference to the attached figures.

FIG. 1 is an isometric, assembled view of a clamp device in accordance with an exemplary embodiment of the present disclosure.

FIG. 2 is an enlarged, cross-sectional view of a portion of the clamp device in FIG. 1, taken along a line II-II thereof.

FIG. 3 is an isometric, assembled view of the clamp device in FIG. 1 holding a work-piece.

FIG. 4 is a cross-sectional view of the clamp device in FIG. 3 holding a work-piece, taken along a line IV-IV thereof.

FIG. 5 is an isometric, assembled view of the clamp device in FIG. 1 holding another work-piece.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and members have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

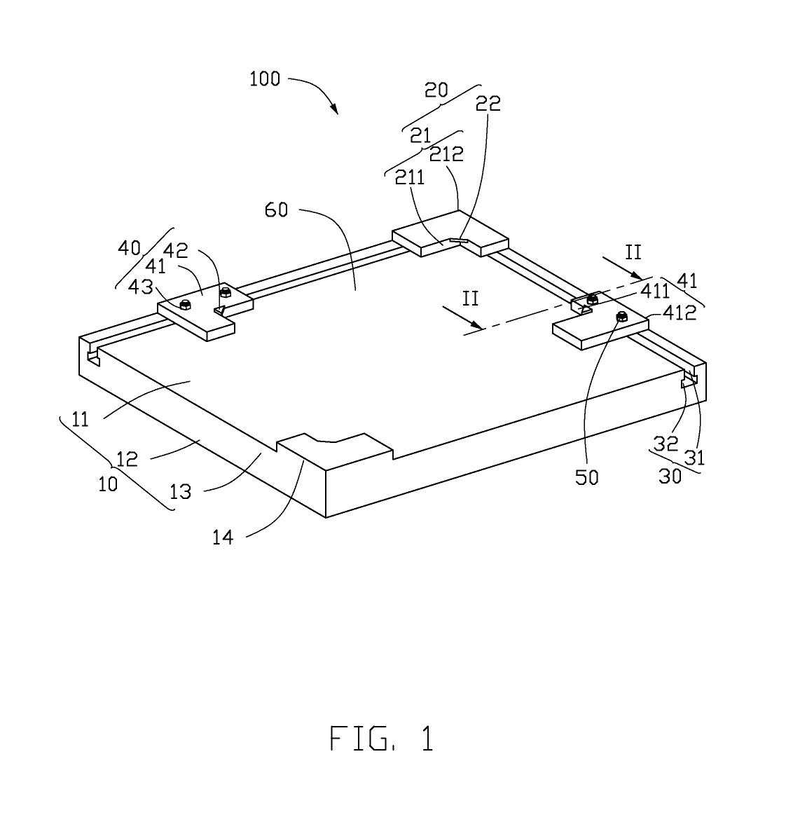

In the present disclosure, a clamp device 100 for holding a rectangular and plate type work-piece 200 is introduced. In this embodiment, the work-piece 200 is a tablet computer. Referring to FIG. 1, the clamp device 100 of the present disclosure includes a base 10, a first positioning member 20 formed on the base 10, two movable members 40 movably coupled to the base 10. Two guiding slots 30 are defined in the base 10. The movable members 40 can slide along the guiding slots 30, respectively. Several connecting members 50 are assembled on the movable members 40 for fixing the movable members 40 onto the base 10.

The base 10 is substantially a plate. The base 10 includes a top surface 11, a bottom surface 12 opposite to the top surface 11, and several sides 13 for interconnecting the top surface 11 and the bottom surface 12. In this embodiment, the base 10 is substantially a rectangle-shaped. A number of the sides 13 of the base 10 is four. The base 10 further includes four right angles 14. Alternatively, the base 10 can be in different sharps according to actual requires.

The first positioning member 20 is formed on one of the right angles 14 of the base 10. The first positioning member 20 can be integratively formed on the base 10. The first positioning member 20 includes a limiting part 21 and a fixing part 22. The limiting part 21 is shaped as a right angle. The limiting part 21 includes an inner right angle 211 and an outer right angle 212. The limiting part 21 is perpendicular to the top surface 11 of the base 10. The limiting part 21 is located on the top surface 11 of the base 10. The limiting part 21 is extended upward and vertical from the top surface 11 of the base 10. The fixing part 22 is shaped as a triangle. The fixing part 22 is located over the top surface 11 of the base 10. The fixing part 22 is extended from the inner right angle 211 of the limiting part 21 and spaced away from the top surface 11 of the base 10.

The two guiding slots 30 are defined on the top surface 11 of the base 10. Each guiding slot 30 is adjacent to a corresponding side 13 of the base 10. The two guiding slots 30 are perpendicular to each other and intersect adjacent to one of the four right angles 14 of the base 10 where the first positioning member 20 is located. One of the guiding slots 30 is penetrated through two opposite sides 13 of the base 10 and the other guiding slot 30 is penetrated though the other two opposite sides 13 of the base 10. Each guiding slot 30 is ladder shaped. Each guiding slot 30 includes a slide slot 31 and a fasten slot 32. The slide slot 31 is recessed from the top surface 11 toward the bottom surface 12 of the base 10 in a vertical direction. In this embodiment, the slide slot 31 is in an elongate shape. The fasten slot 32 is further recessed from a bottom of the slide slot 31 toward the bottom surface 12 of the base 10. In this embodiment, the fasten slot 32 is in another elongate shape. A width of the fasten slot 32 is larger than that of the slide slot 31. A depth of the fasten slot 32 is less than that of the slide slot 31.

The two movable members 40 are movably coupled to the base 10 through the guiding slots 30. The two movable members 40 can slide along the two guiding slots 30, respectively. Each movable member 40 includes a parapet 41 and a blocking piece 42. At least a fixing hole 43 is defined on the parapet 41 for fixing the connecting member 50. In this embodiment, the parapet 41 is shaped as a right angle. One of the two right-angled sides of the parapet 41 is located on the guiding slot 30 and the other one is located on the top surface 11 of the base 10. The parapet 41 includes an inner right angle 411 and an outer right angle 412. The blocking piece 42 is shaped as a triangle. The blocking piece 42 is located over the top surface 11 of the base 10. The blocking piece 42 is extended upward and vertical from the inner right angle 411 of the parapet 41 and spaced away from the top surface 11 of the base 10. Each fixing hole 43 is penetrated through top and bottom surfaces of the parapet 41. In this embodiment, a number of the fixing holes 43 is two. The two fixing holes 43 are spaced from each other. Every fixing hole 43 faces the guiding slot 30 for fixing the connecting member 50.

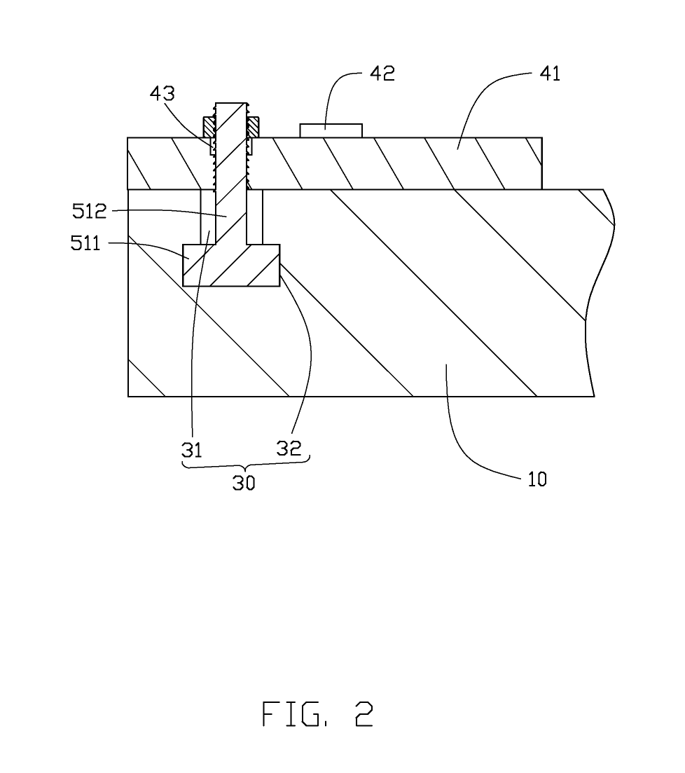

Referring to FIG. 2, the connecting members 50 are received in the guiding slots 30, respectively. And the connecting members 50 can slide in the guiding slots 30. The connecting members 50 are configured for connecting the movable members 40 to the base 10. In this embodiment, the clamp device 100 includes four connecting members 50. And every two connecting members 50 are fixed in one movable member 40. In this embodiment, each connecting member 50 includes a slide component and a fasten component. In this embodiment, the slide component can be a screw 51 and the fasten component can be a matched nut 52. Alternatively, the connecting member 50 can also be introduced as other components. The screw 51 includes a cap 511 and a bolt 512. The cap 511 is rectangular. A width of the cap 511 is in a range from a width of the slide slot 31 and a width of the fasten slot 32. The cap 511 is received in the fasten slot 32. The bolt 512 is formed on a center of the cap 511. The bolt 512 is columnar. A diameter of the bolt 512 is less than a width of the slide slot 31. The bolt 512 is received in the slide slot 31 and protrudes from the top surface 11 of the base 10. The bolts 512 insert through the fixing holes 43 of the movable members 40 for connecting the movable members 40. When the movable members 40 move, the bolts 512 are driven to slide along the guiding slots 30 at the same time. A max-diameter of the nut 52 is larger than a width of the slide slot 31. The nuts 52 are located on the top surface 11 of the base 10. The nuts 52 are configured for fastening the movables 40 onto the base 10 by being matched with the screws 51. When the movable members 40 are fastened on the base 10, the two movable members 40 and the first positioning member 20 together form a rectangular clamping space 60 therein.

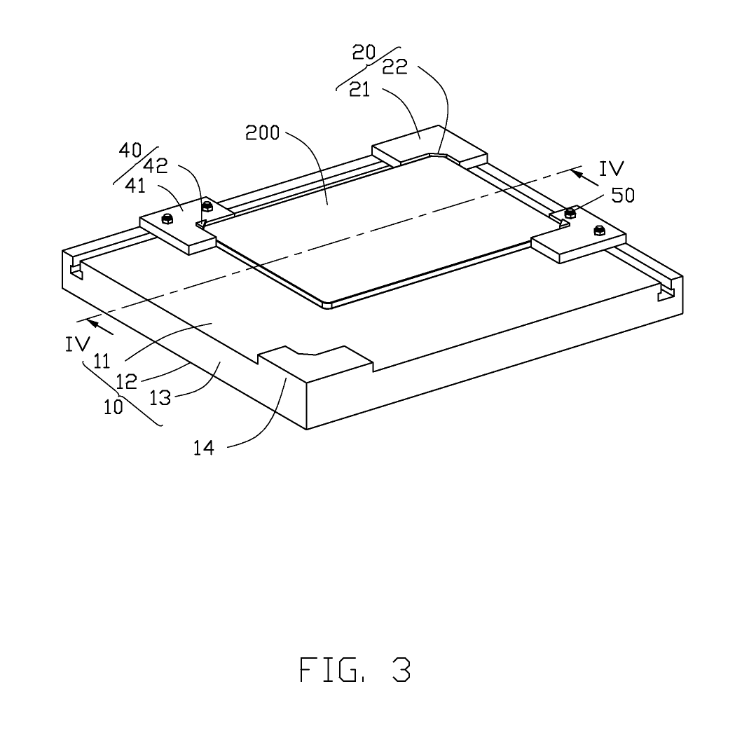

Referring to FIG. 2 and FIG. 3, the clamp device 100 of the present disclosure in the invention is assembled as follow:

The screws 51 of the connecting members 51 are positioned in the guiding slots 30 by sliding into the guiding slots 30 from sides 13 of the base 10. Each guiding slot 30 receives two screws 51. The cap 511 of each screw 51 is received in the fasten slot 32 of the guiding slot 30. The bolt 512 of the screw 51 is received in the slide slot 31 of the guiding slot 30 and protrudes from the top surface 11 of the base 10. Every two bolts 512 of the screws 51 are inserted through the two fixing holes 43 of the movable member 40 into the fasten slot 32, respectively, to assemble the movable members 40 onto the base 10. The movable members 40 are moved to an appointed position for adjusting a size of the clamping space 60 according to an actual size of the work-piece 200. The nuts 52 are fastened to fix the movable members 40 between the top surface 11 of the base 10 and the nuts 52, through being matched with the screws 51.

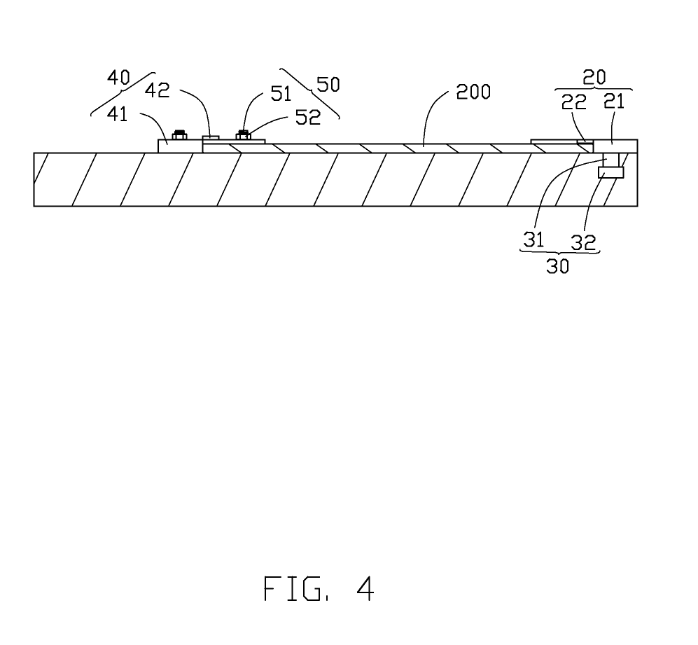

Referring to FIG. 3 and FIG. 4, the clamp device 100 of the present disclosure works as follow:

A plate type work-piece 200, such as a tablet computer, is arranged on the top surface 11 of the base 10. The work-piece 200 is moved on the top surface 11 of the base 10 until one of its right angles is attached to the limiting part 21 of the first positioning member 20. The right angle of the work-piece 200 is located under the fixing part 22 of the first positioning member 20. The movable members 40 are moved until the parapets 41 are attached to the work-piece 200. At the same time, the screws 51 of the connecting members 50 slide in the guiding slots 30 along with the movable members 40. The nuts 52 are assembled and fastened to fix the movable members 40 by being matched with the screws 51. After the work-piece 200 assembled, the limiting part 21 of the first positioning member 20 and the parapets 41 of the movable members 40 limit the work-piece 200 to move in a horizontal direction; the fixing part 22 of the first positioning member 20 and the top surface 11 of the base 10 limit the work-piece 200 move in a vertical direction.

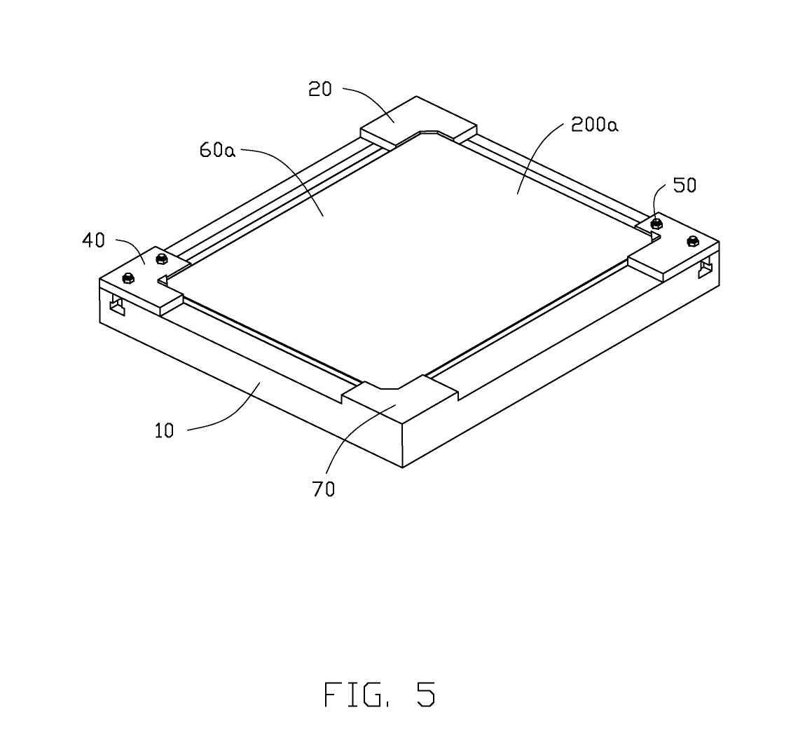

Referring to FIG. 5, the clamp device 100 of the present disclosure may also include a second positioning member 70. A shape and size of the second positioning member 70 are all the same with those of the first positioning member 20. The second positioning member 70 is formed on another right angle 14 of the base 10 to be on the cross with the first positioning member 20. The second positioning member 70, the first positioning member 20 and the two movable members 40 form a clamping space 60a therein with a maximal size for holding a work-piece 200a.

Compared to the traditional clamp devices, the clamp device 100 of the present disclosure in the present invention is provided with two guiding slots 30 designed on the base 10. A size of the clamping space 60 is adjustable by the two movable members 40 sliding along the guiding slots 30 freely, so that the clamp device 100 of the invention can hold work-pieces 200 with different sizes. Thus, clamp devices with different sizes corresponding to different work-pieces can be omitted. Resources and cost can be saved. Furthermore, the clamp device 100 of the invention has advantages of simple structure, easy assembly on the movable members 40, connecting members 50 and the base 10. When members of the clamp device 100 are damaged, only parts of the clamp device 100 need to be replaced, without re-manufacturing the whole clamp device 100.

In addition, the clamp device 100 of the invention clips several angles of the work-piece 200. When the clamp device 100 is used in a test fixture, all features holes on sides of the work-piece 200 can be test by holding the work-piece 200 once, without turning the work-piece 200 and fixing it repetitiously to adjust positions of function holes until not being sheltered from limiting parts.

The embodiment shown and described above is only an example. Many details are often found in the art such as the other features of a clamp device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A clamp device for holding a plate type work-piece comprising:
a base comprising a top surface and a bottom surface, and two guiding slots defined in the base;
a first positioning member formed on base; and
two movable members movably coupled to the base though the guiding slots, respectively;
wherein the two movable members and the first positioning member together form a clamping space.

2. The clamp device of claim 1, wherein the two guiding slots are perpendicular to each other and intersect adjacent to one of four right angles of the base where the first positioning member is located.

3. The clamp device of claim 1, wherein the base further comprises a plurality of sides for interconnecting the top surface and the bottom surface.

4. The clamp device of claim 3, wherein each guiding slot is penetrated through two opposite sides of the base, each guiding slot is ladder shaped.

5. The clamp device of claim 1, wherein each guiding slot comprises a slide slot and a fasten slot, the slide slot is recessed from the top surface toward the bottom surface of the base in a vertical direction, and the fasten slot is further recessed from a bottom of the slide slot toward the bottom surface of the base.

6. The clamp device of claim 5, wherein a width of the fasten slot is larger than that of the slide slot, and a depth of the fasten slot is less than that of the slide slot.

7. The clamp device of claim 1, wherein the first positioning member comprises a limiting part and a fixing part, and the limiting part further comprises an inner right angle and an outer inner right angle, and the inner right angle and an outer inner right angle are perpendicular to the top surface of the base.

8. The clamp device of claim 7, wherein the limiting part is extended upward and vertical from the top surface of the base, the fixing part is extended from the inner right angle of the limiting part and spaced away from the top surface of the base.

9. The clamp device of claim 5, wherein the clamp device further comprises a plurality of connecting members, and the connecting members are received in the guiding slots and fixed on the movable members.

10. The clamp device of claim 9, wherein the connecting members can slide in the guiding slots, each connecting member comprises a slide component and a fasten component matched with the slide component.

11. The clamp device of claim 10, wherein the slide component is received in the guiding slot and protrudes from the top surface of the base, and the fasten component is located on the top surface of the base.

12. The clamp device of claim 11, wherein each movable member comprises a parapet and a blocking piece, and the parapet comprises an inner right angle and an outer right angle.

13. The clamp device of claim 12, wherein the blocking piece is extended upward and vertical from the inner right angle of the parapet and spaced away from the top surface of the base.

14. The clamp device of claim 12, wherein at least a fixing hole is defined on the parapet for fixing the connecting member.

15. The clamp device of claim 14, wherein the slide component of the connecting member is inserted through the fixing hole of the movable member.

16. The clamp device of claim 2, wherein the clamp device further comprises a second positioning member, a shape and size of the second positioning member are all the same with those of the first positioning member.

17. The clamp device of claim 16, wherein the second positioning member is formed on the base to be on a cross with the first positioning member.
